(19) United States
(12) Patent Application Publication
(10) Pub. No.: US 2026/0044005 A1
(43) Pub. Date: Feb. 12, 2026

(54) High Occlusion Eye Tracking

(71) Applicant: Apple Inc., Cupertino, CA (US)

(72) Inventors: Tom Sengelaub, Oakland, CA (US); Hua Gao, San Jose, CA (US); Lionel E Edwin, San Jose, CA (US); Oliver G Wenisch, Potsdam (DE)

(73) Assignee: Apple Inc., Cupertino, CA (US)

(21) Appl. No.: 19/292,789

(22) Filed: Aug. 6, 2025

Related U.S. Application Data
(60) Provisional application No. 63/681,745, filed on Aug. 9, 2024.

(51) Int. Cl. G02B 27/01; G02B 27/00; G06T 7/73

(52) U.S. Cl. CPC G02B 27/0172; G02B 27/0093; G06T 7/75; G02B 2027/0138; G02B 2027/014; G02B 2027/0178; G06T 2207/10016; G06T 2207/10048; G06T 2207/20084

(57) ABSTRACT

An eye tracking system that includes a reference estimator that estimates a rotational model of the eye with N (e.g., five) degrees of freedom and a gaze estimator that estimates a gaze vector with the rotational model as a constraint. The rotational model may include a centroid region rather than a fixed eye center. The rotational model may remain static until a trigger event, at which time a new rotational model is estimated. One or both estimators may include a trained neural network. Model and gaze estimation may depend on eye features extracted from images; the eye features may include glints, but other eye features than glints may be used if the device does not include dedicated eye-illuminating light sources. A glint-based gaze vector and a feature-based gaze vector may be estimated, and a final gaze vector may be determined from the two estimated gaze vectors.

### PRIORITY CLAIM

This application claims benefit of priority to U.S. Provisional Application Ser. No. 63/681,745, entitled “High Occlusion Eye Tracking,” filed Aug. 9, 2024, and which is hereby incorporated herein by reference in its entirety.

### BACKGROUND

Extended reality (XR) systems such as mixed reality (MR) or augmented reality (AR) systems combine computer generated information (referred to as virtual content) with real world images or a real-world view to augment, or add content to, a user's view of the world. XR systems may thus be utilized to provide an interactive user experience for multiple applications, such as applications that add virtual content to a real-time view of the viewer's environment, interacting with virtual training environments, gaming, remotely controlling drones or other mechanical systems, viewing digital media content, interacting with the Internet, or the like.

Eye tracking is the process of monitoring an eye to determine the direction of the eye's vision, also called gaze. For example, the location of the pupil can provide an approximate gaze tracking metric. As an example, Purkinje images, also called glints, can provide a means for a gaze tracking system to track movement of the pupil. Other eye features may also be used to track movement of the eye.

### SUMMARY

Various embodiments of methods and apparatus for eye tracking in a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses. Alternatively, the HMD may include opaque display screens positioned in front of the user's eyes via which images or video of the environment captured by the one or more cameras can be displayed for viewing by a user, possibly augmented by virtual content in an XR system, and typically through optics or eyepieces positioned between the displays and the user's eyes.

In a device that implements an eye tracking system, an eye tracking algorithm implemented by the system may track the position of the pupil or other eye features based on images of the eyes captured by eye-facing camera(s) to determine gaze direction. In an example eye tracking system, images captured by the eye tracking camera may be input to a feature detection process, which may be implemented by one or more processors of a controller of the HMD. Results of the process are passed to a gaze estimation process, for example implemented by one or more processors of the controller, to estimate the user's current point of gaze (or gaze vector) based in part on a three-dimensional model of the eye, as well as on current position of the eye with respect to the device. The model of the user's eye may be generated based on images of the eye captured by the eye-facing camera(s). The model may include, but is not limited to, information on the center of the eye, center of the pupil, eye center to pupil distance, inter-pupillary distance (IPD), and other information about the pupil, iris, and cornea surface. Note that the gaze tracking may be performed for one or for both eyes.

A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in two DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

For an eye tracking system in some devices, such as a glasses-type HMD, the form factor of the device may impose limitations on the placement of the camera(s) and illumination elements (light sources), as well as on other components such as processors and power sources. Traditional gaze tracking techniques may be limited due to the structural restrictions of such devices. A gaze tracking system in such a device may require gaze tracking components and techniques that meet the architectural and functional restraints of such devices, including power and compute restraints.

To reduce complexity in devices such as glasses-type HMD, embodiments of an eye tracking system are described that use only one camera per eye. In some embodiments, the camera may be closer to the eye than in conventional systems. In an eye tracking system with only one camera that is close to the face, there will be occlusions, so a more robust gaze tracking paradigm is needed than those that are conventionally used. Thus, embodiments may implement a globe modeling technique, where a 3D rotational model with no fixed center point of rotation and thus with N (e.g., five) degrees of freedom (DoF) of movement in space, is used for the eye rather than a conventional surface model. Embodiments may thus model the eyeball and how it rotates, and when the eye tracking camera captures an image, that image can be mapped onto the rotational model, with the mapping used in determining current eye position and gaze vector. In addition, instead of using a fixed-point eye center for an eye model as in conventional systems, embodiments may use an eye center region, or centroid region, in the rotational model. When estimating gaze vectors, the eye center may be constrained within the centroid region, rather than assuming the eye center as a fixed point. This method better approximates the way eyes actually rotate, as center of rotation may actually be different for different rotational directions.

In addition, in devices such as glasses-type HMD, placement of an array of light sources in the device can be problematic. Thus, some embodiments of an eye tracking system are described that may not include an array of dedicated light sources, but instead may rely on ambient light and/or a reduced number (one or two) of light sources. In these embodiments, other features than glints may be used in tracking eye location and movement. In some embodiments, a combination of glints and other eye features may be used. (A glint is a reflection of a light source off the cornea of the eye).

Further, embodiments of eye tracking methods and apparatus are described that leverage the assumption that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. Thus, the eye estimation problem can be split into two pipelines:
a reference estimator that estimates the N (e.g., five) DoF position eye with respect to the camera/device (the rotational model); and
a gaze estimator that estimates only the two DoF rotation of the eye based at least in part on the rotational model.

In embodiments, an initial N DoF estimation may be performed by the reference estimator to estimate a rotational model. Subsequently, the gaze estimator is used to track elevation and azimuth (two DoF) of the eye(s) constrained by the rotational model until a trigger event occurs indicating that a new rotational model needs to be estimated. A new rotational model is then estimated by the reference estimator, after which the gaze estimator is used to track elevation and azimuth based on the new rotational model. This may continue as long as the device is in use. A trigger event may be a timed event (e.g., every 200 milliseconds) or a detected event (e.g., detection of movement of the device with respect to the eye(s) by one or more sensors of the device).

In some embodiments, the gaze estimator may include a trained neural network that estimates a gaze vector from input eye image information under the constraint of a current rotational model provided by the reference estimator. In some embodiments, the reference estimator may include a trained neural network that estimates a rotational model based on one or more eye images and other sensor input.

In some embodiments, there may be a separate glint-based estimator that attempts to estimate a glint-based gaze vector based on glint information extracted from an image of the eye. If successful (e.g., if a glint-based gaze vector can be estimated above a certain confidence level), the glint-based gaze vector may then be used in combination with other eye features to estimate a final gaze vector, or alternatively the glint-based gaze vector and a gaze vector estimated based on other features than glints may be evaluated to provide a final gaze vector. In both cases, if a glint-based gaze vector cannot be estimated above a level of confidence, the eye tracking system may instead rely on other eye features to estimate the gaze vector.

Embodiments of the eye tracking methods and apparatus as described herein may thus enable a desired reporting rate (gaze estimation) with low latency while maintaining eye estimation (gaze/pupil/vergence) performance and satisfying the architectural and functional restraints of devices such as a glasses-type HMD, including form factor, power, and compute restraints.

### BRIEF DESCRIPTION OF THE DRAWINGS

FIG. 1A graphically illustrates splitting the eye estimation problem into a two DoF problem and a 5 DoF problem in a device that includes an eye tracking system, according to some embodiments.

FIG. 1B graphically illustrates a device with a single camera and single light source in which occlusions may affect quality of images captured by the camera, according to some embodiments.

FIG. 2 illustrates estimating rotational models and gaze vectors in different pipelines in a device that includes an eye tracking system, according to some embodiments.

FIG. 3 graphically illustrates a rotational model, according to some embodiments.

FIG. 4 is a block diagram of an eye tracking system that includes a reference estimator and a gaze estimator, according to some embodiments.

FIGS. 5A and 5B illustrate a reference estimator and a gaze estimator, respectively, according to some embodiments.

FIG. 6 is a flowchart of a method that splits the eye estimation problem into a rotational model estimation and gaze estimation in a device that includes an eye tracking system, according to some embodiments.

FIG. 7 is a block diagram illustrating a method of combining glint-free eye tracking with glint-based eye tracking, according to some embodiments.

FIG. 8 is a block diagram illustrating another method of combining glint-free eye tracking with glint-based eye tracking, according to some embodiments.

FIG. 9 is a flowchart illustrating a method of combining glint-free eye tracking with glint-based eye tracking, according to some embodiments.

FIG. 10 is a flowchart illustrating another method of combining glint-free eye tracking with glint-based eye tracking, according to some embodiments.

FIG. 11 is a flowchart illustrating a method of augmenting glint-free eye tracking with glint-based eye tracking, according to some embodiments.

FIGS. 12A through 12C illustrate example devices in which the methods of FIGS. 1 through 11 may be implemented, according to some embodiments.

FIG. 13 is a block diagram illustrating an example device that may include components and implement methods as illustrated in FIGS. 1 through 11, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware-for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

Various embodiments of methods and apparatus for eye tracking in a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses. Alternatively, the HMD may include opaque display screens positioned in front of the user's eyes via which images or video of the environment captured by the one or more cameras can be displayed for viewing by a user, possibly augmented by virtual content in an XR system, and typically through optics or eyepieces positioned between the displays and the user's eyes. While embodiments of the eye tracking methods and apparatus are generally described herein with respect to HMDs, such as HMDs used in XR systems, embodiments may be applied in any application or system that employs eye or gaze tracking, for example health monitoring systems or techniques.

In a device that implements an eye tracking system, an eye tracking algorithm implemented by the system may track the position of the pupil or other eye features based on images of the eyes captured by eye-facing camera(s) to determine gaze direction. In an example eye tracking system, images captured by the eye tracking camera may be input to a feature detection process, which may be implemented by one or more processors of a controller of the HMD. Results of the process are passed to a gaze estimation process, for example implemented by one or more processors of the controller, to estimate the user's current point of gaze (or gaze vector) based in part on a three-dimensional model of the eye, as well as on current position of the eye with respect to the device. The model of the user's eye may be generated based on images of the eye captured by the eye-facing camera(s). The model may include, but is not limited to, information on the center of the eye, center of the pupil, eye center to pupil distance, inter-pupillary distance (IPD), and other information about the pupil, iris, and cornea surface. Note that the gaze tracking may be performed for one or for both eyes.

Accurate eye tracking may be required for several reasons including but not limited to dynamic display distortion and color correction, and is especially important as displays get smaller. A device that implements eye tracking may include a display positioned in front of the user's eyes, and eyepieces located between the user's eyes and the display. Dynamic display distortion may be applied to images to be displayed to account for distortion caused by the lenses with respect to the user's current gaze direction as detected by the eye tracking system. Color correction or other image corrections may also be applied to frames based on the current gaze direction as detected by the eye tracking system.

A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in two DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

For an eye tracking system in some devices, such as a glasses-type HMD, the form factor of the device may impose limitations on the placement of the camera(s) and illumination elements (light sources), as well as on other components such as processors and power sources. Traditional gaze tracking techniques may be limited due to the structural restrictions of such devices. A gaze tracking system in such a device may require gaze tracking components and techniques that meet the architectural and functional restraints of such devices, including power and compute restraints.

To reduce complexity in devices such as glasses-type HMD, embodiments of an eye tracking system are described that use only one camera per eye. In some embodiments, the camera may be closer to the eye than in conventional systems. In an eye tracking system with only one camera that is close to the face, there will be occlusions, so a more robust gaze tracking paradigm is needed than those that are conventionally used. Thus, embodiments may implement a globe modeling technique in which a 3D rotational model with no fixed center point of rotation and thus with N (three, four, five, or more) degrees of freedom (DoF) of movement in space is used for the eye model rather than a conventional surface model. Embodiments may thus model the eyeball and how it rotates, and when the eye tracking camera captures an image, that image can be mapped onto the rotational model, with the mapping used in determining current eye position and gaze vector. In addition, instead of using a fixed-point eye center for an eye model as in conventional systems, some embodiments may use an eye center region, or centroid region, in the rotational model. When estimating the rotational model and estimating gaze vectors, the eye center may be constrained within the centroid region, rather than assuming the eye center as a fixed point. This method better approximates the way eyes actually rotate, as center of rotation may actually be different for different rotational directions.

In addition, in devices such as glasses-type HMD, placement of an array of light sources in the device can be problematic. Thus, some embodiments of an eye tracking system are described that may not include an array of dedicated light sources, but instead may rely on ambient light and/or a reduced number (one or two) of light sources. In these embodiments, other features than glints may be used in tracking eye location and movement. In some embodiments, a combination of glints and other eye features may be used. (A glint is a reflection of a light source off the cornea of the eye).

Further, embodiments of eye tracking methods and apparatus are described that leverage the assumption that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. Thus, the eye estimation problem can be split into two pipelines:
a reference estimator that estimates the N (e.g., five) DoF position eye with respect to the camera/device (the rotational model); and
a gaze estimator that estimates only the two DoF rotation of the eye based at least in part on the rotational model.

In embodiments, an initial N (e.g., five) DoF estimation may be performed by the reference estimator to establish a rotational model. Subsequently, the gaze estimator is used to track elevation and azimuth (two DoF) of the eye(s) constrained by the rotational model until a trigger event occurs indicating that a new rotational model needs to be estimated. A new rotational model is then estimated by the reference estimator, after which the gaze estimator is used to track elevation and azimuth based on the new rotational model. This may continue as long as the device is in use. A trigger event may be a timed event (e.g., every 200 milliseconds) or a detected event (e.g., detection of movement of the device with respect to the eye(s) by one or more sensors of the device).

In some embodiments, the gaze estimator may include a trained neural network that estimates a gaze vector from input eye image information under the constraint of a current rotational model provided by the reference estimator. In some embodiments, the reference estimator may include a trained neural network that estimates a rotational model based on one or more eye images and other sensor input.

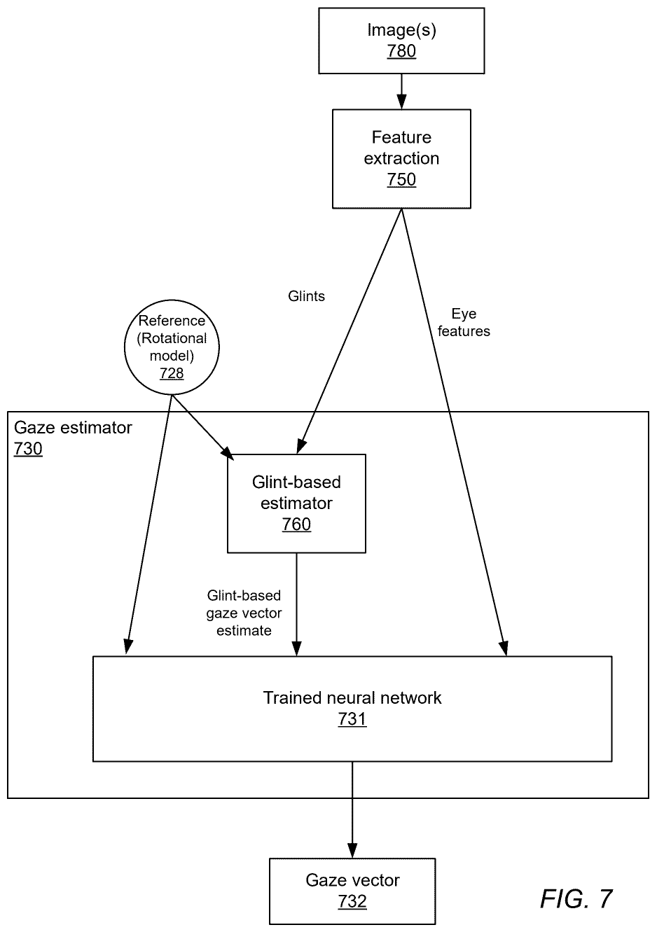

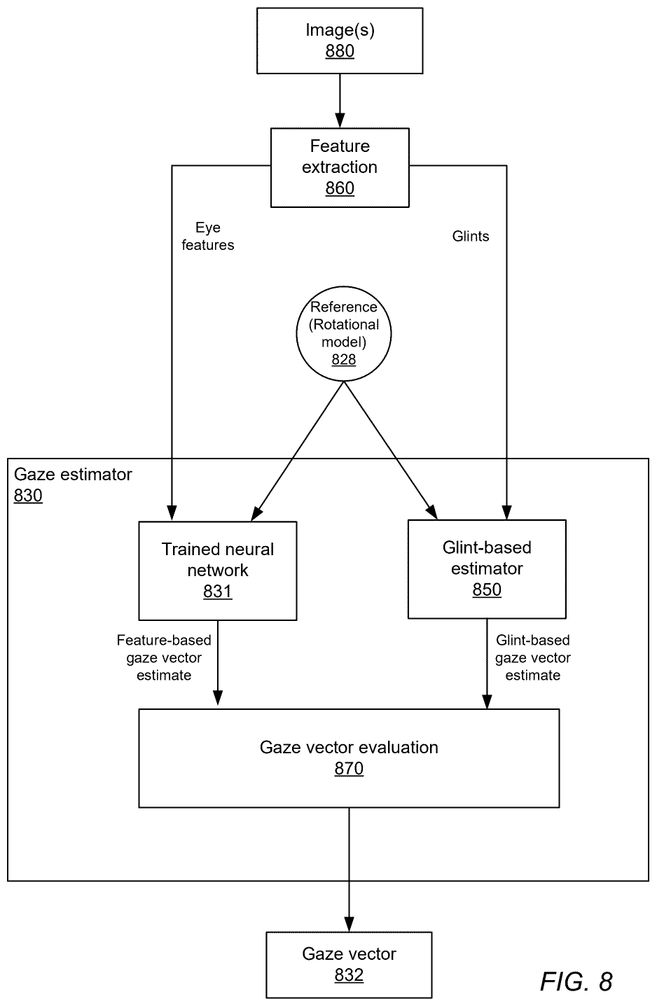

In some embodiments as illustrated in FIGS. 7 through 10, there may be a separate glint-based estimator that attempts to estimate a glint-based gaze vector based on glint information extracted from an image of the eye. If successful (e.g., if a glint-based gaze vector can be estimated above a certain confidence level), the glint-based gaze vector may then be used in combination with other eye features to estimate a final gaze vector (FIG. 7), or the glint-based gaze vector and a gaze vector estimated based on other features than glints may be evaluated to provide a final gaze vector (FIG. 8). In both cases, if a glint-based gaze vector cannot be estimated above a level of confidence, the eye tracking system may instead rely on other eye features to estimate the gaze vector.

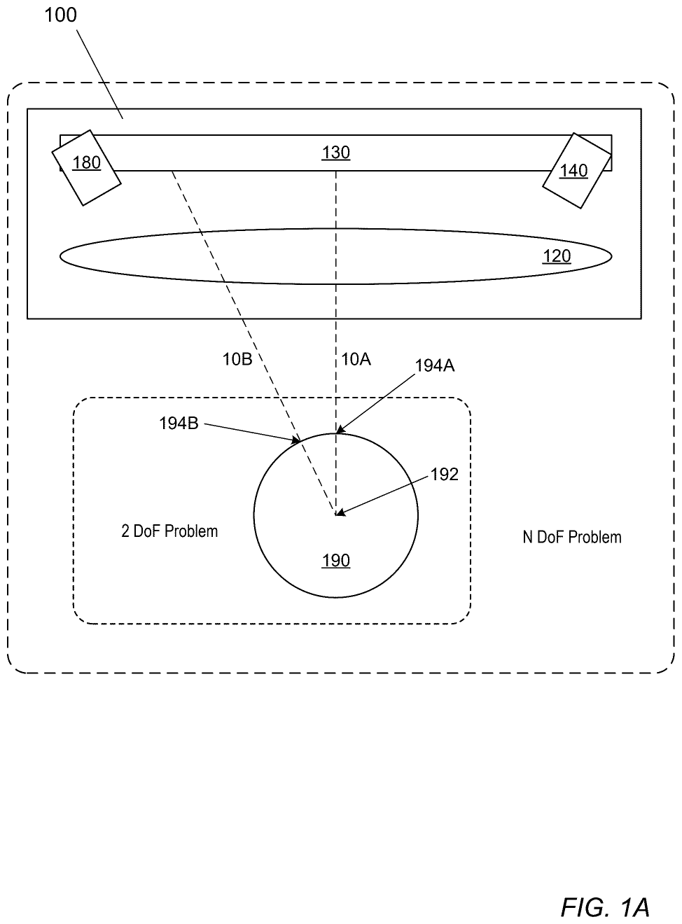

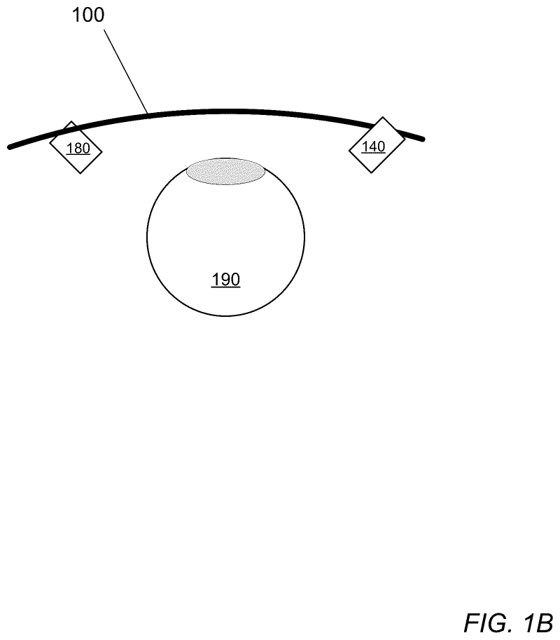

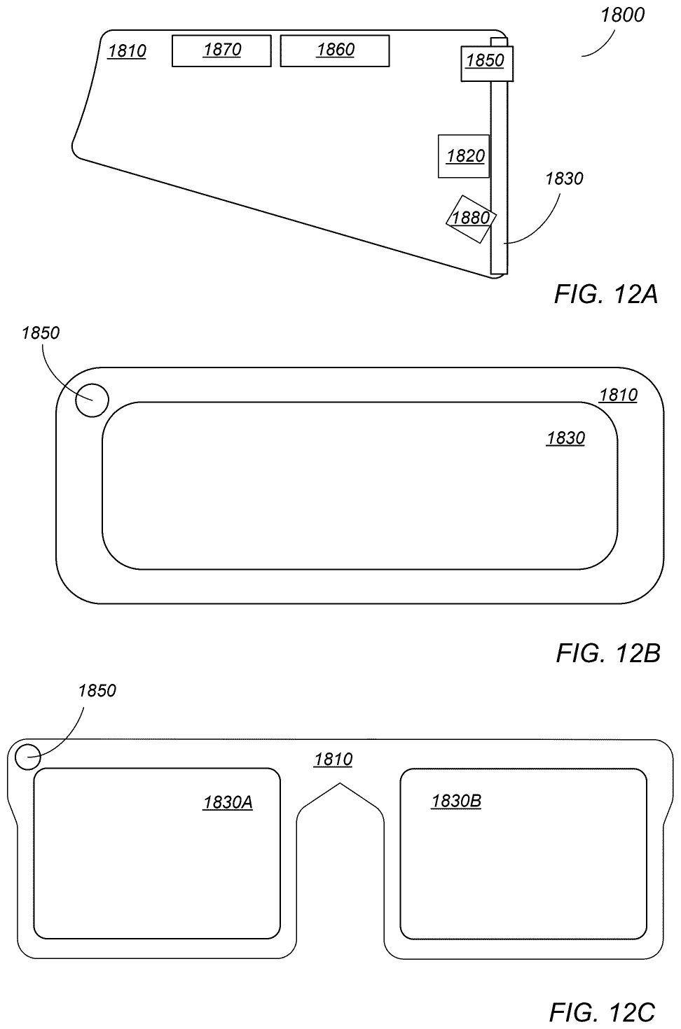

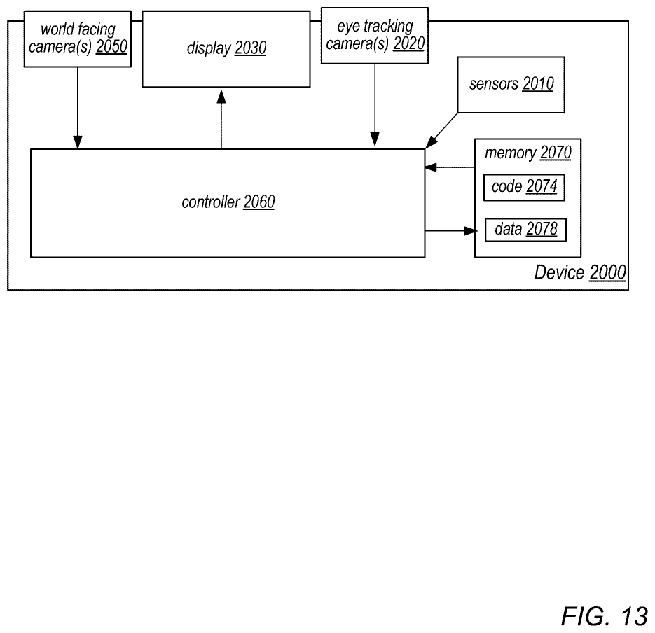

The methods as illustrated in FIGS. 1 through 11 may be implemented by processes executing on or by one or more processors of a controller which is communicatively coupled to other components such as cameras, lights, and sensors in a device such as an HMD. Example devices in which the methods and apparatus may be implemented are illustrated in FIGS. 12A-12C and FIG. 13.

FIG. 1A graphically illustrates splitting the eye estimation problem into a two DoF problem and a 5 DoF problem in a device that includes an eye tracking system, according to some embodiments. In some embodiments, a device 100 (e.g., a HMD) may include a display 130 and optics (or “eyepieces”) 120 positioned in front of a user's eye 190. An eye-facing camera 140 may be positioned to capture video or images of the eye 190, in particular of the iris, pupil, and cornea surface, either directly or through the optics 120.

In some embodiments, device 100 may also include one or more light sources 180 such as LED or infrared point light sources that emit light (e.g., light in the IR portion of the spectrum) towards the user's eye or eyes. The light source(s) may produce glints—reflections of the light source(s) off the cornea of the eye. In some embodiments, the glints may be captured in images of the eye by camera 140, and the glint images may be processed to provide structured information about the current position of the eye.

In some embodiments, during device calibration or registration, a rotational model of the user's eye may be generated based on images of the eye captured by the eye-facing camera 140. The rotational model may include, but is not limited to, information on the center or centroid 192 of the eye, center of the pupil, eye center to pupil distance, inter-pupillary distance (IPD), and other information about the pupil, iris, and cornea surface. In use, an eye tracking system may estimate the position of the pupil based on images of the eyes captured by eye-facing camera 140 to determine, based in part on the eye model, the current gaze direction. FIG. 1A shows the eye with the pupil at a first position 194A and a second position 194B, with respective gaze vectors 10A and 10B determined from at least the center 192 of the eye and the currently detected pupil position 194.

A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in 2 DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

For an eye tracking system in some devices, such as a glasses-type HMD, the form factor of the device may impose limitations on the placement of the camera(s) 140 and illumination elements (if any), as well as on other components such as processors and power sources. FIG. 1B graphically illustrates a device 100 with a single camera 140 and single light source 180 in which occlusions, due to positioning of the camera 140, may affect quality of images of the eye 190 captured by the camera 140, according to some embodiments. A display screen of device 100 may be located relatively close to eye 190 when compared to conventional HMDs. Camera 140 may, for example, be located to the side, or above, or more generally in any position relative to, a display screen of device 100. Similarly, light source 180 may be located in various positions with respect to the display screen. Note that in some embodiments device 100 may not include a light source 180. Traditional gaze tracking techniques may be limited due to the structural restrictions of such devices. A gaze tracking system in such a device may require gaze tracking components and techniques that meet the architectural and functional restraints of such devices, including power and computation restraints.

Embodiments of eye tracking methods and apparatus are described that leverage the assumption that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. In addition, there may be a 1 to 1 mapping between 2D (elevation and eye rotation) angles and 2D eye feature movement in image space (movement of an eye feature such as a glint or pupil feature is correlated with eye rotation). Thus, the eye estimation problem can be split into two pipelines or estimators:
a reference estimator that estimates the N (e.g., five) DoF position eye with respect to the camera/device (the rotational model); and
a gaze estimator that estimates only the two DoF rotation of the eye based at least in part on the rotational model.

The reference estimator generates a rotational model. The gaze estimator estimates the delta orientation of the eye (azimuth and elevation) constrained by the rotational model. The gaze estimator continues to estimate the gaze vector based on a current rotational model until a trigger event occurs indicating that a new rotational model needs to be estimated. A new rotational model is then estimated by the reference estimator, after which the gaze estimator is used to track elevation and azimuth based on the new rotational model. Note that while embodiments are generally described in reference to one eye, the methods described herein may be applied to both eyes in some embodiments.

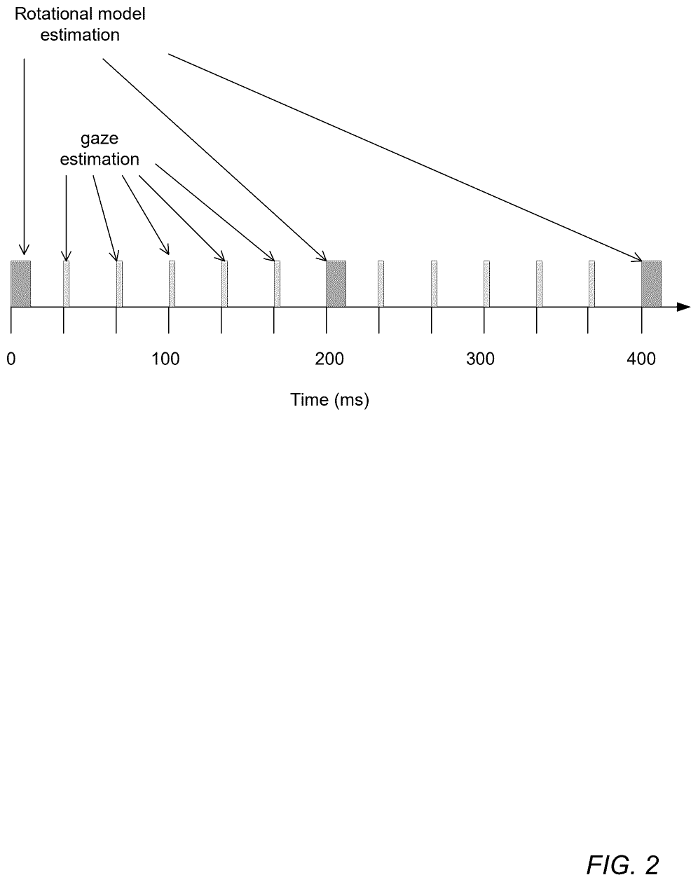

FIG. 2 illustrates estimating rotational models and gaze vectors in different pipelines in a device that includes an eye tracking system, according to some embodiments. A conventional eye tracking algorithm solves an eye estimation problem in N (e.g., five) degrees of freedom (N DoF). A current position of the eye with respect to the eye tracking camera (or more generally, with the device) in three dimensions (X, Y, Z), and rotation of the eye in 2 DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

Embodiments of eye tracking methods and apparatus are described that leverage the assumption that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. Thus, the eye estimation problem can be split into two pipelines:
a reference estimator that estimates the N (e.g., five) DoF position eye with respect to the camera/device (the rotational model); and
a gaze estimator that estimates only the two DoF rotation of the eye based at least in part on the rotational model.

FIG. 2 shows an eye tracking timeline in milliseconds, starting from an initial point (e.g., when the device is turned on by the user and registered or calibrated). In embodiments, an initial estimation may be performed by the reference estimator to estimate a rotational model. Subsequently, the gaze estimator is used to track elevation and azimuth (two DoF) of the eye(s) until a trigger event occurs indicating that a new rotational model needs to be estimated. A new rotational model is then estimated by the reference estimator, after which the high-cadence pipeline is used to track elevation and azimuth. This may continue as long as the device is in use. A trigger event may be a timed event (e.g., every 200 milliseconds) or a detected event (e.g., detected movement of the device with respect to the eye(s) by one or more sensors of the device).

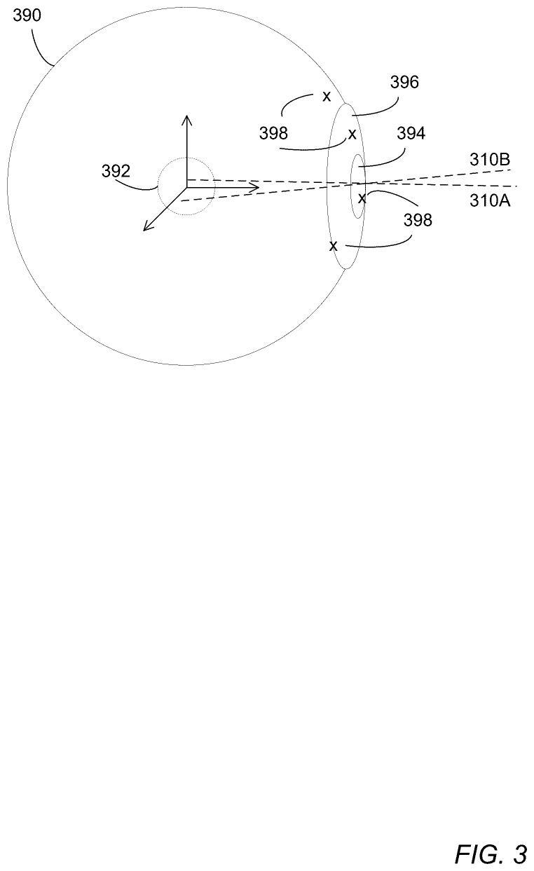

FIG. 3 graphically illustrates a 3D rotational model, according to some embodiments. Embodiments may implement a globe modeling technique in which a 3D rotational model 390 with no fixed center point of rotation and thus with N (e.g., five) degrees of freedom (DoF) of movement in space is used for the eye model rather than a conventional surface model. Embodiments may thus model the eyeball and how it rotates, and when the eye tracking camera captures an image, that image can be mapped onto the rotational model 390, with the mapping used in determining current eye position and gaze vector 310. In addition, instead of using a fixed-point eye center for an eye model as in conventional systems, embodiments may use an eye center region, or centroid region 392, in the rotational model 390. When estimating gaze vectors 310, the eye center may be constrained within the centroid region 392, rather than assuming the eye center as a fixed point. This method better approximates the way eyes actually rotate, as center of rotation may actually be different for different rotational directions.

FIG. 3 also shows that various eye features 398 or combinations thereof may be used to reconstruct eye rotation and thus determine gaze vectors 310. Eye features 398 may include glints, pupil 394 or iris 396 features, limbus features, or in general any feature that can be used to reconstruct eye rotation. Some embodiments of an eye tracking system may not include an array of dedicated light sources, but instead may rely on ambient light and/or a reduced number (one or two) of light sources. In these embodiments, other features 398 than glints may be used in modeling the eye rotation and estimating gaze vectors 310. In some embodiments, a combination of glints and other eye features may be used. (A glint is a reflection of a light source off the cornea of the eye).

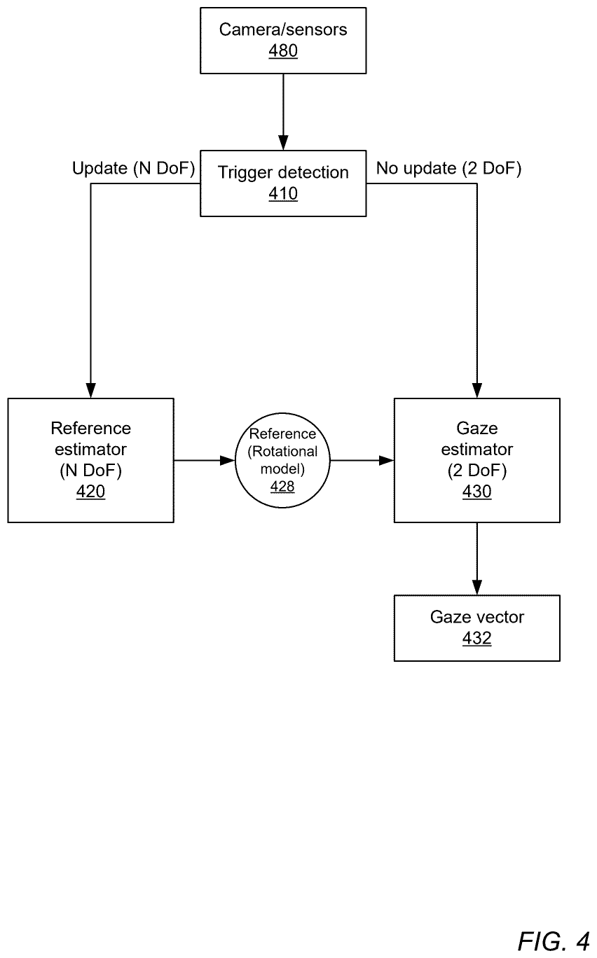

FIG. 4 is a block diagram of an eye tracking system that includes a reference estimator and a gaze estimator, according to some embodiments. Some embodiments of eye tracking methods and apparatus may leverage the assumption that, while the user's eyes may move often and rapidly at any time, the position of the eye with respect to the device remains relatively fixed for much longer periods. Thus, the eye estimation problem can be split into two parts:
a reference estimator 420 that estimates the N (e.g., five) DoF position eye with respect to the camera/device (the rotational model 428); and
a gaze estimator 430 that estimates only the two DoF (gaze vector 432) based at least in part on the rotational model 428.

In embodiments, an initial N (e.g., five) DoF estimation may be performed by the reference estimator 420 based on input from camera/sensors 480 to establish a rotational model 428. Subsequently, the gaze estimator 430 is used to track elevation and azimuth (two DoF) of the eye(s) based on eye features derived from images captured by the camera 480 and constrained by the rotational model 428 to estimate gaze vectors 432 until a trigger event is detected 410 indicating that a new rotational model 428 needs to be estimated. A new rotational model 428 is then estimated by the reference estimator 420, after which the gaze estimator 428 is used to track elevation and azimuth to estimate gaze vectors 432 based on eye features and the new rotational model 428. This may continue as long as the device is in use. A trigger event may be a timed event (e.g., every 200 milliseconds) or a detected event (e.g., detection of movement of the device with respect to the eye(s) by one or more sensors 480 of the device).

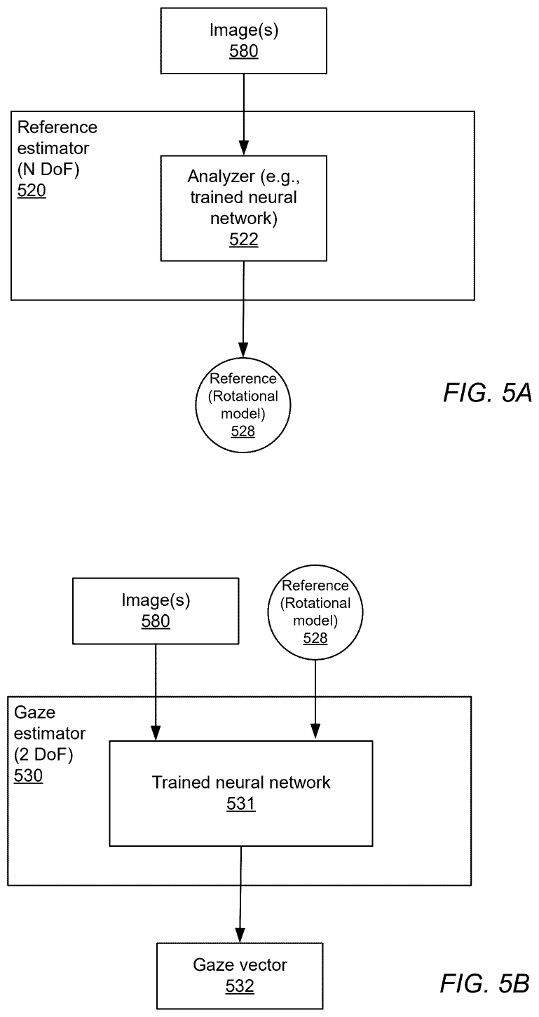

FIG. 5A is a block diagram illustrating a reference estimator 520, according to some embodiments. In some embodiments, the reference estimator 520 may include a analyzer 522 that estimates a 3D rotational model 528 based on eye features extracted from one or more eye images 580 and possibly other sensor input. In some embodiments, analyzer 522 may include a trained neural network. However, in some embodiments, other types of analyzers 522 than a neural network may be used to estimate the 3D rotational model 528, in some embodiments. In some embodiments, the rotational model 528 has no fixed center point of rotation and has N (e.g., five) degrees of freedom (DoF) of movement in space. In some embodiments, other estimators than a neural network 522 may be used to generate the rotational model 528.

FIG. 5B is a block diagram illustrating a gaze estimator 530, according to some embodiments. In some embodiments, the gaze estimator 530 may include a trained neural network 531 that estimates a gaze vector 532 from input eye image 580 information (eye features) under the constraint of a current rotational model 528 provided by the reference estimator 520. Eye features may include glints, pupil or iris features, limbus features, or in general any feature that can be used to estimate a gaze vector 532 under the constraints of a rotational model 528. In some embodiments, the gaze estimator 530 may apply interpolation based on the rotational model 528 and the image(s) 580 to estimate gaze 532 between the references 528 generated by the reference estimator 520. The gaze estimator 530 is used to track elevation and azimuth (two DoF) of the eye(s) until a trigger event occurs indicating that a new rotational model 528 needs to be estimated by the reference estimator 520. A trigger event may be a timed event (e.g., every 200 milliseconds) or a detected event (e.g., detected movement of the device with respect to the eye(s) by one or more sensors of the device).

Some embodiments of an eye tracking system may not include an array of dedicated light sources, but instead may rely on ambient light and/or a reduced number (one or two) of light sources. In these embodiments, other features than glints may be used in modeling the eye rotation and estimating gaze vectors 532. In some embodiments, a combination of glints and other eye features may be used. (A glint is a reflection of a light source off the cornea of the eye).

In some embodiments, the input rotational model 528 has no fixed center point of rotation and N (e.g., five) degrees of freedom (DoF) of movement in space. However, in some embodiments, the input model 528 may have a fixed center of rotation (a fixed center point) as a constraint. In some embodiments, other estimators than a neural network 531 may be used to generate the gaze vector 532.

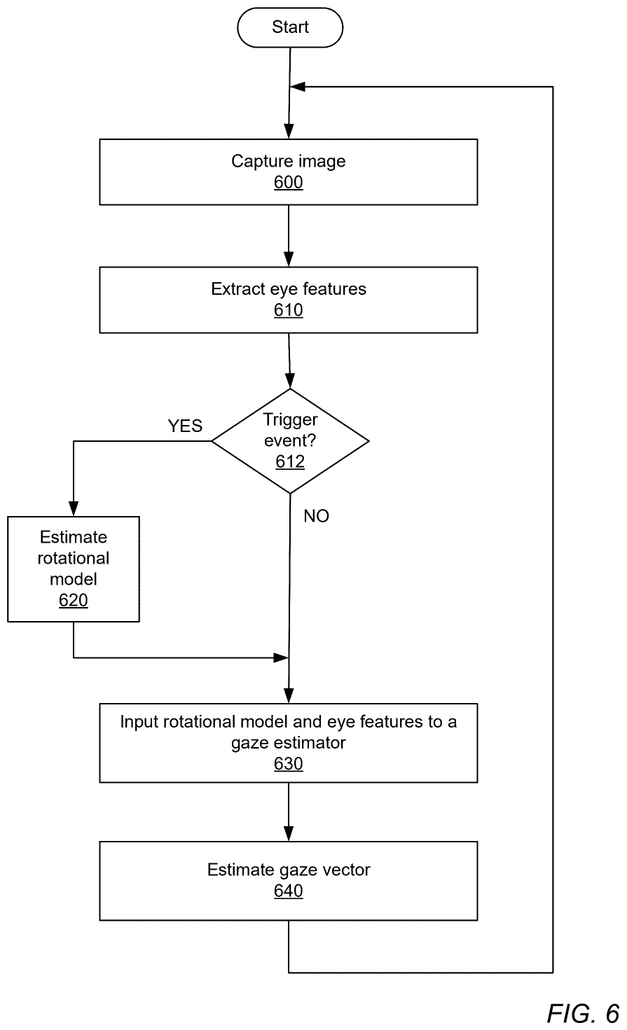

FIG. 6 is a flowchart of a method that splits the eye estimation problem into a rotational model estimation and gaze estimation in a device that includes an eye tracking system, according to some embodiments. As indicated at 600, an image (or images) is captured by an eye-facing camera. As indicated at 610, the image(s) may be processed to extract various eye features. Eye features may include glints, pupil or iris features, limbus features, or in general any feature that can be used to estimate an eye model and/or a gaze vector. In some embodiments, glints are not used.

At 612, a check is made to determine if a trigger event has occurred. A trigger event may be a timed event (e.g., every 200 milliseconds) or a detected event (e.g., detection of movement of the device with respect to the eye(s) by one or more sensors of the device). (Turning the device on may also be considered a trigger event). If a trigger event has occurred, then at 620 a rotational model of the eye is estimated, for example by a reference estimator as illustrated in FIGS. 4 and 5A. The eye model may be estimated based at least in part of the extracted eye features and/or inputs from one or more other sensors of the device. In some embodiments, the reference estimator may implement a trained neural network that outputs a rotational model based on eye feature and/or sensor inputs. At 612, if a trigger event has not occurred, then an existing rotational eye model is to be used.

At 630, the current rotational eye model and extracted eye features are input to a gaze estimator, for example a gaze estimator as illustrated in FIGS. 4 and 5B. At 640, the gaze estimator estimates a gaze vector from the input eye features under the constraint of the current rotational model. In some embodiments, the gaze estimator implements a trained neural network as illustrated in FIG. 5B; the eye features and rotational model are input to the neural network, which outputs an estimated gaze vector. The gaze vector may then be used in various processes of the device.

In some embodiments, the rotational eye model includes a centroid region rather than a fixed center point of rotation as in conventional eye tracking systems. The gaze estimator is thus constrained within the centroid region for the eye center rather than to a single fixed point. This allows the rotation of the gaze vector with respect to the device to be modeled more accurately than in conventional systems, as the human eye rotates around different points in different directions, not around a fixed center point.

As indicated by the arrow returning to element 600, the method may continue as long as the device is in use.

### Combining Glint-Free Eye Tracking with Glint-Based Eye Tracking

As shown in FIG. 3, various eye features 398 or combinations thereof may be used to reconstruct eye rotation and thus determine gaze vectors 310. Eye features 398 may include glints, pupil 394 or iris 396 features, limbus features, or in general any feature that can be used to reconstruct eye rotation. Some embodiments of an eye tracking system may not include an array of dedicated light sources, but instead may rely on ambient light (with no integrated light sources) and/or a reduced number (one or two) of light sources. These embodiments may not rely on glints in estimating position or rotation of the eye; instead, other features 398 than glints may be used in modeling the eye rotation and estimating gaze vectors 310.

As illustrated in FIG. 1A, in some embodiments, a device 100 may include one or more light sources 180 such as LED or infrared point light sources that emit light (e.g., light in the IR portion of the spectrum) towards the user's eye or eyes. The light source(s) may produce glints—reflections of the light source(s) off the cornea of the eye. In some embodiments, the glints may be captured in images of the eye by camera 140, and the glint images may be processed to provide structured information about the current position of the eye which may then be used to estimate reliable gaze vectors. However, in an eye tracking system with only one camera that is close to the face, there may be occlusions or angles of rotation at which a sufficient set of glints cannot be obtained. FIG. 1B graphically illustrates a device 100 with a single camera 140 and single light source 180 in which occlusions, due to positioning of the camera 140, may affect quality of images of the eye 190 captured by the camera 140, according to some embodiments. A display screen of device 100 may be located relatively close to eye 190 when compared to conventional HMDs. Camera 140 may, for example, be located to the side, or above, or more generally in any position relative to, a display screen of device 100. Similarly, light source 180 may be located in various positions with respect to the display screen. Note that in some embodiments device 100 may not include a light source 180.

To provide more accurate and consistent gaze tracking in a variety of conditions, embodiments of an eye tracking system are described that may implement methods that utilize glints in combination with non-glint features of the eye. In some embodiments, glints may be used to augment non-glint feature-based eye tracking (referred to as glint-free eye tracking) if and when glints are obtainable. In some embodiments, glint-free eye tracking may be used to augment glint-based eye tracking when glints are insufficient.

In some embodiments, the eye features input to a gaze estimator as illustrated in FIG. 6 may include glints as well as pupil or iris features, limbus features, or in general any feature that can be used to estimate a gaze vector. The eye features, including glints, may be input to a trained neural network as illustrated in FIG. 5B. If there are no or insufficient glints in the input features, the neural network may estimate the gaze vector based solely or primarily on the other eye features. If a good set of glints is available, the neural network may use the glints along with other eye features in estimating the gaze vector.

However, in some embodiments as illustrated in FIGS. 7 through 10, there may be a separate glint-based estimator that attempts to estimate a glint-based gaze vector based on glint information extracted from an image of the eye. If successful (e.g., if a glint-based gaze vector can be estimated above a certain confidence level), the glint-based gaze vector may then be used in combination with other eye features to estimate a final gaze vector (FIG. 7), or the glint-based gaze vector and a gaze vector estimated based on other features than glints may be evaluated to provide a final gaze vector (FIG. 8). In both cases, if a glint-based gaze vector cannot be estimated above a level of confidence, the eye tracking system may instead rely on other eye features to estimate the gaze vector.

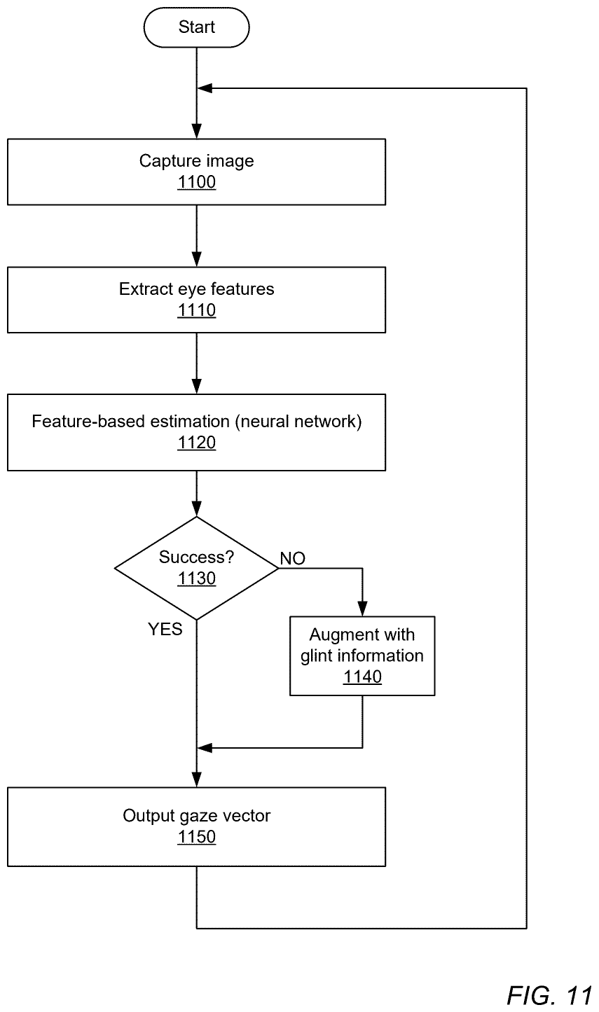

In some embodiments, a gaze estimator may first attempt to estimate a gaze vector based on other eye features than glints. If a feature-based gaze vector cannot be estimated above a certain level of confidence, then the gaze estimator may augment the feature-based gaze vector estimate with glint information, or may augment or replace the feature-based gaze vector estimate with a glint-based gaze vector estimate (FIG. 11).

FIG. 7 is a block diagram illustrating a method of combining glint-free eye tracking with glint-based eye tracking, according to some embodiments. An eye tracking system may include a feature extraction 750 component that extracts eye features, including but not limited to glints, from input image(s) 780, and a gaze estimator 730. In some embodiments, the gaze estimator 730 may include a glint-based estimator 760 that estimates a gaze vector from input eye image information (glints) under the constraint of a rotational model 728 provided by a reference estimator. The gaze estimator 730 may also include a trained neural network 731 that estimates a gaze vector 732 from the glint-based gaze vector estimate in combination with other eye features under the constraint of the rotational model 728. If a glint-based gaze vector cannot be estimated above a level of confidence, the trained neural network 731 may instead rely only on other eye features to estimate the gaze vector.

FIG. 8 is a block diagram illustrating another method of combining glint-free eye tracking with glint-based eye tracking, according to some embodiments. An eye tracking system may include a feature extraction 850 component that extracts eye features, including but not limited to glints, from input image(s) 880, and a gaze estimator 830. In some embodiments, the gaze estimator 830 may include a glint-based estimator 860 that estimates a gaze vector from input eye image information (glints) under the constraint of a rotational model 828 provided by a reference estimator. The gaze estimator 830 may also include a trained neural network 831 that estimates a gaze vector from eye features under the constraint of the rotational model 728. The gaze estimator 830 may also include a gaze vector evaluation 870 component that receives as input a glint-based gaze vector estimate and a feature-based gaze vector estimate and evaluates the two estimates to determine a final gaze vector 832 estimate. Thus, if a glint-based gaze vector can be estimated above a level of confidence, the gaze estimator 830 may rely on, or provide more weight to, the glint-based gaze vector. But if a glint-based gaze vector cannot be estimated above a level of confidence, the gaze estimator 830 may instead rely only on, or primarily on, a gaze vector estimated from other eye features by the neural network 831.

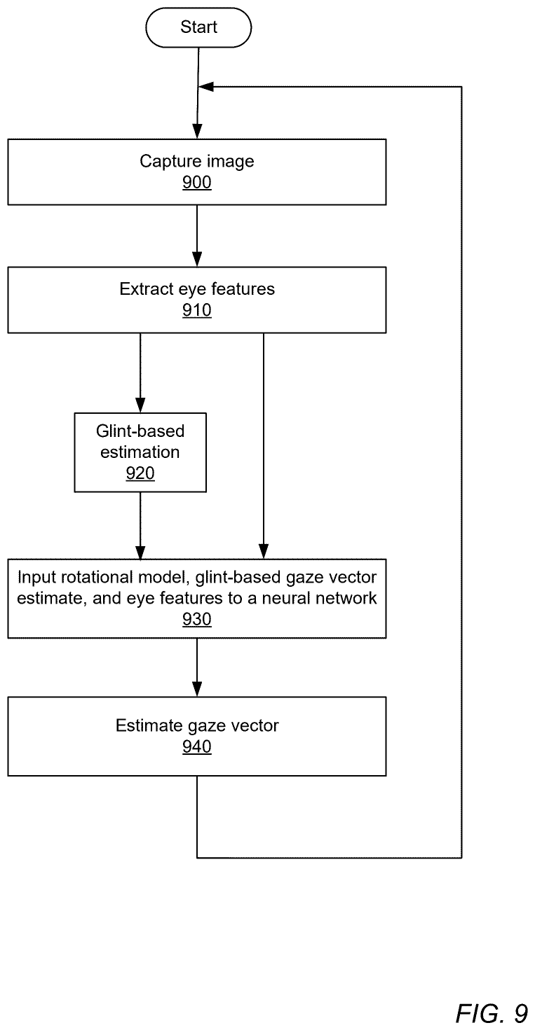

FIG. 9 is a flowchart illustrating a method of combining glint-free eye tracking with glint-based eye tracking, according to some embodiments. As indicated at 900, an image (or images) is captured by an eye-facing camera. As indicated at 910, the image(s) may be processed to extract various eye features. Eye features may include glints, pupil or iris features, limbus features, or in general any feature that can be used to estimate an eye model and/or a gaze vector. As indicated at 920, a gaze vector may be estimated from input eye image information (glints). At 930, the rotational eye model, glint-based gaze vector estimate, and extracted eye features are input to a gaze estimator. At 940, the gaze estimator estimates a gaze vector from the input eye features and glint-based gaze vector estimation under the constraint of the rotational model. In some embodiments, the gaze estimator implements a trained neural network as illustrated in FIG. 7; the eye features, glint-based gaze vector, and rotational model are input to the neural network, which outputs a final estimated gaze vector. If a glint-based gaze vector cannot be estimated above a level of confidence, the gaze estimator may instead rely only on other eye features to estimate the final gaze vector. The gaze vector may then be used in various processes of the device. As indicated by the arrow returning to element 900, the method may continue as long as the device is in use.

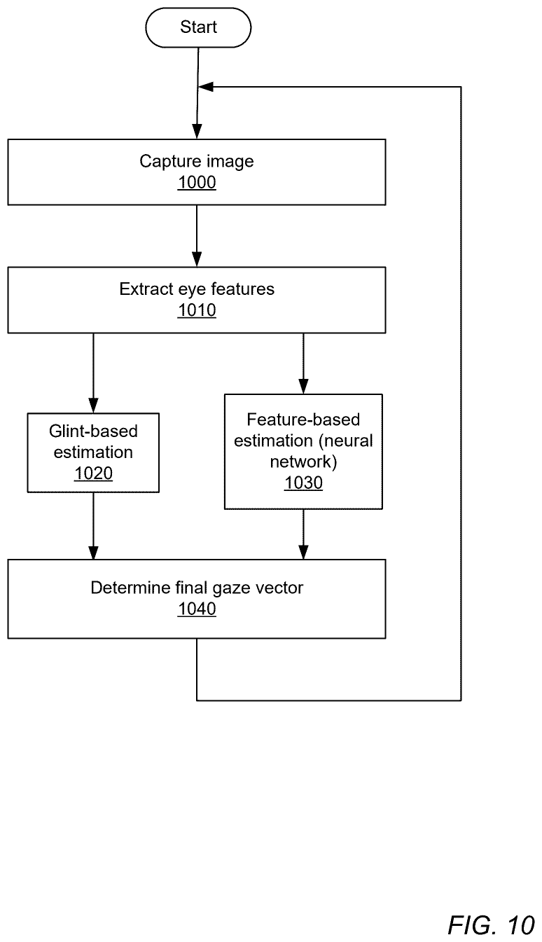

FIG. 10 is a flowchart illustrating another method of combining glint-free eye tracking with glint-based eye tracking, according to some embodiments. As indicated at 1000, an image (or images) is captured by an eye-facing camera. As indicated at 1010, the image(s) may be processed to extract various eye features. Eye features may include glints, pupil or iris features, limbus features, or in general any feature that can be used to estimate an eye model and/or a gaze vector. As indicated at 1020, a gaze vector may be estimated from input eye image information (glints). As indicated at 1030, a gaze vector may also be estimated by a trained neural network from eye features. At 1040, the glint-based gaze vector estimate and the feature-based gaze vector estimate may be evaluated to determine a final gaze vector. If a glint-based gaze vector can be estimated above a level of confidence, the eye tracking system may rely on, or provide more weight to, the glint-based gaze vector. But if a glint-based gaze vector cannot be estimated above a level of confidence, the eye tracking system may instead rely only on, or primarily on, a gaze vector estimated from other eye features by the neural network. The gaze vector may then be used in various processes of the device. As indicated by the arrow returning to element 1000, the method may continue as long as the device is in use.

FIG. 11 is a flowchart illustrating a method of augmenting glint-free eye tracking with glint-based eye tracking, according to some embodiments. In some embodiments, a gaze estimator may first attempt to estimate a gaze vector based on other eye features than glints. If a feature-based gaze vector cannot be estimated above a certain level of confidence, then the gaze estimator may augment the feature-based gaze vector estimate with glint information, or may augment or replace the feature-based gaze vector estimate with a glint-based gaze vector estimate.

As indicated at 1100, an image (or images) is captured by an eye-facing camera. As indicated at 1110, the image(s) may be processed to extract various eye features. Eye features may include glints, pupil or iris features, limbus features, or in general any feature that can be used to estimate an eye model and/or a gaze vector. As indicated at 1120, a feature-based gaze vector may be estimated from input eye image information (eye features) other than glints. At 1130, if the feature-based gaze vector estimation was successful (e.g., above a confidence level), the feature-based gaze vector may be output at 1150. At 1130, if the feature-based gaze vector estimate was not successful, then at 1140 the gaze estimator may augment the feature-based gaze vector estimate with glint information, or may augment or replace the feature-based gaze vector estimate with a glint-based gaze vector estimate, and output the augmented or replaced gaze vector at 1150. The gaze vector may then be used in various processes of the device. As indicated by the arrow returning to element 1100, the method may continue as long as the device is in use.

The methods as illustrated in FIGS. 1 through 11 may be implemented by processes executing on or by one or more processors of a controller which is communicatively coupled to other components such as cameras and sensors in a device such as an HMD. Example devices in which the methods and apparatus may be implemented are illustrated in FIGS. 12A-12C and FIG. 13.

FIGS. 12A through 12C illustrate example devices in which the methods of FIGS. 1 through 11 may be implemented, according to some embodiments. Note that the HMDs 1800 as illustrated in FIGS. 12A through 12C are given by way of example, and are not intended to be limiting. In various embodiments, the shape, size, and other features of an HMD 1800 may differ, and the locations, numbers, types, and other features of the components of an HMD 1800 and of the eye imaging system. FIG. 12A shows a side view of an example HMD 1800, and FIGS. 12B and 12C show alternative front views of example HMDs 1800, with FIG. 12A showing device that has one lens 1830 that covers both eyes and FIG. 12B showing a device that has right 1830A and left 1830B lenses.

HMD 1800 may include lens(es) 1830, mounted in a wearable housing or frame 1810. HMD 1800 may be worn on a user's head (the “wearer”) so that the lens(es) is disposed in front of the wearer's eyes. In some embodiments, an HMD 1800 may implement any of various types of display technologies or display systems. For example, HMD 1800 may include a display system that directs light that forms images (virtual content) through one or more layers of waveguides in the lens(es) 1830; output couplers of the waveguides (e.g., relief gratings or volume holography) may output the light towards the wearer to form images at or near the wearer's eyes. As another example, HMD 1800 may include a direct retinal projector system that directs light towards reflective components of the lens(es); the reflective lens(es) is configured to redirect the light to form images at the wearer's eyes.

In some embodiments, HMD 1800 may also include one or more sensors that collect information about the wearer's environment (video, depth information, lighting information, etc.) and about the wearer (e.g., eye or gaze tracking sensors, head motion sensors, etc.). The sensors may include one or more of, but are not limited to one or more eye tracking cameras 1820 (e.g., infrared (IR) cameras) that capture views of the user's eyes, one or more world-facing or PoV cameras 1850 (e.g., RGB video cameras) that can capture images or video of the real-world environment in a field of view in front of the user, and one or more ambient light sensors that capture lighting information for the environment. Cameras 1820 and 1850 may be integrated in or attached to the frame 1810. In some embodiments, HMD 1800 may also include one or more light sources 1880 such as LED or infrared point light sources that emit light (e.g., light in the IR portion of the spectrum) towards the user's eye or eyes. However, some embodiments may not include light sources 1880, and may rely on ambient light for imaging of the eye. In addition, some embodiments may include only one eye tracking camera 1820 per eye.

A controller 1860 for the XR system may be implemented in the HMD 1800, or alternatively may be implemented at least in part by an external device (e.g., a computing system or handheld device) that is communicatively coupled to HMD 1800 via a wired or wireless interface. Controller 1860 may include one or more of various types of processors, image signal processors (ISPs), graphics processing units (GPUs), coder/decoders (codecs), system on a chip (SOC), CPUs, and/or other components for processing and rendering video and/or images. In some embodiments, controller 1860 may render and composite frames (each frame including a left and right image) that include virtual content based at least in part on inputs obtained from the sensors and from an eye tracking system, and may provide the frames to the display system.

Memory 1870 for the XR system may be implemented in the HMD 1800, or alternatively may be implemented at least in part by an external device (e.g., a computing system) that is communicatively coupled to HMD 1800 via a wired or wireless interface. The memory 1870 may, for example, be used to record video or images captured by the one or more cameras 1850 integrated in or attached to frame 1810. Memory 1870 may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

While FIGS. 12A through 12C only show light sources 1880 and camera(s) 1820 and 1850 for one eye, embodiments may include light sources 1880 and camera(s) 1820 and 1850 for each eye, and gaze tracking may be performed for both eyes. In addition, the light sources, 1880, eye tracking camera 1820 and PoV camera 1850 may be located elsewhere than shown. Some embodiments may not include light sources 1880.

Embodiments of an HMD 1800 as illustrated in FIGS. 12A-12C may, for example, be used in augmented or mixed (AR) applications to provide augmented or mixed reality views to the wearer. HMD 1800 may include one or more sensors, for example located on external surfaces of the HMD 1800, that collect information about the wearer's external environment (video, depth information, lighting information, etc.); the sensors may provide the collected information to controller 1860 of the XR system. The sensors may include one or more visible light cameras 1850 (e.g., RGB video cameras) that capture video of the wearer's environment that, in some embodiments, may be used to provide the wearer with a virtual view of their real environment. In some embodiments, video streams of the real environment captured by the visible light cameras 1850 may be processed by the controller 1860 of the HMD 1800 to render augmented or mixed reality frames that include virtual content overlaid on the view of the real environment, and the rendered frames may be provided to the display system. In some embodiments, input from the eye tracking camera 1820 may be used in a gaze tracking process executed by the controller 1860 to track the gaze/pose of the user's eyes for use in rendering the augmented or mixed reality content for display. In addition, one or more of the methods as illustrated in FIGS. 1 through 11 may be implemented in the HMD to implement eye tracking in the device.

FIG. 13 is a block diagram illustrating an example device that may include components and implement methods as illustrated in FIGS. 1 through 11, according to some embodiments.

In some embodiments, an XR system may include a device 2000 such as a headset, helmet, goggles, or glasses. Device 2000 may implement any of various types of display technologies. For example, device 2000 may include a transparent or translucent display 2060 (e.g., eyeglass lenses) through which the user may view the real environment and a medium integrated with display 2060 through which light representative of virtual images is directed to the wearer's eyes to provide an augmented view of reality to the wearer.

In some embodiments, device 2000 may include a controller 2060 configured to implement functionality of the XR system and to generate frames (each frame including a left and right image) that are provided to display 2030. In some embodiments, device 2000 may also include memory 2070 configured to store software (code 2074) of the XR system that is executable by the controller 2060, as well as data 2078 that may be used by the XR system when executing on the controller 2060. In some embodiments, memory 2070 may also be used to store video captured by camera 2050. In some embodiments, device 2000 may also include one or more interfaces (e.g., a Bluetooth technology interface, USB interface, etc.) configured to communicate with an external device (not shown) via a wired or wireless connection. In some embodiments, at least a part of the functionality described for the controller 2060 may be implemented by the external device. The external device may be or may include any type of computing system or computing device, such as a desktop computer, notebook or laptop computer, pad or tablet device, smartphone, hand-held computing device, game controller, game system, and so on.

In various embodiments, controller 2060 may be a uniprocessor system including one processor, or a multiprocessor system including several processors (e.g., two, four, eight, or another suitable number). Controller 2060 may include central processing units (CPUs) configured to implement any suitable instruction set architecture, and may be configured to execute instructions defined in that instruction set architecture. For example, in various embodiments controller 2060 may include general-purpose or embedded processors implementing any of a variety of instruction set architectures (ISAs), such as the x86, PowerPC, SPARC, RISC, or MIPS ISAs, or any other suitable ISA. In multiprocessor systems, each of the processors may commonly, but not necessarily, implement the same ISA. Controller 2060 may employ any microarchitecture, including scalar, superscalar, pipelined, superpipelined, out of order, in order, speculative, non-speculative, etc., or combinations thereof. Controller 2060 may include circuitry to implement microcoding techniques. Controller 2060 may include one or more processing cores each configured to execute instructions. Controller 2060 may include one or more levels of caches, which may employ any size and any configuration (set associative, direct mapped, etc.). In some embodiments, controller 2060 may include at least one graphics processing unit (GPU), which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 2060 may include one or more other components for processing and rendering video and/or images, for example image signal processors (ISPs), coder/decoders (codecs), etc.

Memory 2070 may include any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used to store processed data, such as Flash or other “hard drive” technologies.

In some embodiments, device 2000 may include one or more sensors 2010 that collect information about the user's environment (video, depth information, lighting information, head motion and pose information etc.). The sensors 2010 may provide the information to the controller 2060 of the XR system. In some embodiments, the sensors 2010 may include, but are not limited to, at least one visible light camera (e.g., an RGB video camera) 2050, ambient light sensors, an IMU (inertial measurement unit), and at least one eye tracking camera 2020. In some embodiments, device 2000 may also include one or more IR light sources; light from the light sources reflected off the eye may be captured by the eye tracking camera 2020. Gaze tracking algorithms implemented by controller 2060 may process images or video of the eye captured by the camera 2020 to determine eye pose and gaze direction. In addition, one or more of the methods as illustrated in FIGS. 1 through 11 may be implemented in device 2000 to implement gaze or eye tracking in a device.

In some embodiments, device 2000 may be configured to render and display frames to provide an augmented or mixed reality (MR) view for the user based at least in part according to sensor inputs, including input from the eye tracking camera 2020. The MR view may include renderings of the user's environment, including renderings of real objects in the user's environment, based on video captured by one or more video cameras that capture high-quality, high-resolution video of the user's environment for display. The MR view may also include virtual content (e.g., virtual objects, virtual tags for real objects, avatars of the user, etc.) generated by the XR system and composited with the displayed view of the user's real environment.

### Extended Reality

A real environment refers to an environment that a person can perceive (e.g., see, hear, feel) without use of a device. For example, an office environment may include furniture such as desks, chairs, and filing cabinets; structural items such as doors, windows, and walls; and objects such as electronic devices, books, and writing instruments. A person in a real environment can perceive the various aspects of the environment, and may be able to interact with objects in the environment.

An extended reality (XR) environment, on the other hand, is partially or entirely simulated using an electronic device. In an XR environment, for example, a user may see or hear computer generated content that partially or wholly replaces the user's perception of the real environment. Additionally, a user can interact with an XR environment. For example, the user's movements can be tracked and virtual objects in the XR environment can change in response to the user's movements. As a further example, a device presenting an XR environment to a user may determine that a user is moving their hand toward the virtual position of a virtual object, and may move the virtual object in response. Additionally, a user's head position and/or eye gaze can be tracked and virtual objects can move to stay in the user's line of sight.

Examples of XR include augmented reality (AR), virtual reality (VR) and mixed reality (MR). XR can be considered along a spectrum of realities, where VR, on one end, completely immerses the user, replacing the real environment with virtual content, and on the other end, the user experiences the real environment unaided by a device. In between are AR and MR, which mix virtual content with the real environment.

VR generally refers to a type of XR that completely immerses a user and replaces the user's real environment. For example, VR can be presented to a user using a head mounted device (HMD), which can include a near-eye display to present a virtual visual environment to the user and headphones to present a virtual audible environment. In a VR environment, the movement of the user can be tracked and cause the user's view of the environment to change. For example, a user wearing a HMD can walk in the real environment and the user will appear to be walking through the virtual environment they are experiencing. Additionally, the user may be represented by an avatar in the virtual environment, and the user's movements can be tracked by the HMD using various sensors to animate the user's avatar.

AR and MR refer to a type of XR that includes some mixture of the real environment and virtual content. For example, a user may hold a tablet that includes a camera that captures images of the user's real environment. The tablet may have a display that displays the images of the real environment mixed with images of virtual objects. AR or MR can also be presented to a user through an HMD. An HMD can have an opaque display, or can use a see-through display, which allows the user to see the real environment through the display, while displaying virtual content overlaid on the real environment.

The following clauses describe various examples embodiments consistent with the description provided herein.
Clause 1. A device, comprising:
a camera configured to capture images of an eye; and
a reference estimator comprising one or more processors configured to estimate a rotational model of the eye with at least three degrees of freedom, wherein a center of the eye is not constrained within the rotational model; and
a gaze estimator comprising one or more processors configured to estimate a two degree of freedom gaze vector from one or more eye features extracted from images of the eye captured by the camera under constraint of the rotational model that was estimated by the reference estimator.
Clause 2. The device as recited in clause 1, wherein, to estimate a gaze vector from the one or more eye features under constraint of the current rotational model, the gaze estimator inputs a current rotational model and the eye features to a neural network, wherein the neural network estimates the gaze vector from the input eye features under constraint of the current rotational model.
Clause 3. The device as recited in clause 1, wherein position of the eye with respect to the device is represented in the rotational model in three degrees of freedom as (X, Y, Z) coordinates in an image space, and wherein rotation of the eye and the gaze vector are represented in two degrees of freedom as azimuth and elevation.
Clause 4. The device as recited in clause 1, wherein, in estimating the gaze vector from the input eye features under constraint of the rotational model, a center of the eye used in estimating the gaze vector is not constrained to a single point.
Clause 5. The device as recited in clause 1, wherein the reference estimator is configured to process one or more images captured by the camera to generate the rotational model of the eye in response to a trigger event.
Clause 6. The device as recited in clause 5, wherein, to process the one or more images captured by the camera to generate a rotational model of the eye, the reference estimator is configured to:
extract at least one feature of the eye from the one or more images; and
generate the rotational model based at least in part on the extracted one or more features.
Clause 7. The device as recited in clause 6, wherein the at least one feature includes one or more of glints, pupil features, iris features, and limbus features.
Clause 8. The device as recited in clause 5, wherein, to process one or more images captured by the camera to generate the rotational model, the reference estimator is configured to input at least one feature of the eye extracted from one or more images captured by the camera to a neural network that outputs an estimate of the rotational model.
Clause 9. The device as recited in clause 5, wherein the trigger event is a timed event or a detected event.
Clause 10. The device as recited in clause 1, wherein the one or more eye features extracted from an image captured by the camera that are input to the gaze estimator include one or more of glints, pupil features, iris features, and limbus features.
Clause 11. The device as recited in clause 1, wherein the device is a head-mounted device (HMD) of an extended reality (XR) system.
Clause 12. A method, comprising:
performing, by a controller comprising one or more processors:
   estimating a rotational model of the eye with at least three degrees of freedom, wherein a center of the eye is not constrained within the rotational model; and
   estimating a two degree of freedom gaze vector from one or more eye features extracted from images of the eye captured by the camera under constraint of the rotational model of the eye that was estimated by the reference estimator.

Clause 13. The method as recited in clause 12, wherein estimating a gaze vector from the one or more eye features under constraint of the current rotational model comprises inputting the current rotational model and the eye features to a neural network, wherein the neural network estimates the gaze vector from the input eye features under constraint of the current rotational model.

Clause 14. The method as recited in clause 12, wherein the position of the eye with respect to the device is represented in the rotational model in three degrees of freedom as (X, Y, Z) coordinates in an image space, and wherein rotation of the eye and the gaze vector are represented in two degrees of freedom as azimuth and elevation.

Clause 15. The method as recited in clause 12, wherein, in estimating the gaze vector from the input eye features under constraint of the rotational model, a center of the eye used in estimating the gaze vector is not constrained to a single point.
Clause 16. The method as recited in clause 12, further comprising processing one or more images captured by the camera to generate the rotational model of the eye in response to a trigger event.
Clause 17. The method as recited in clause 16, wherein processing the one or more images captured by the camera to generate a rotational model of the eye comprises:
extracting at least one feature of the eye from the one or more images; and
generating the rotational model based at least in part on the extracted one or more features;
wherein the at least one feature includes one or more of glints, pupil features, iris features, and limbus features.
Clause 18. The method as recited in clause 16, wherein processing one or more images captured by the camera to generate the rotational model comprises inputting at least one feature of the eye extracted from one or more images captured by the camera into a neural network that outputs an estimate of the rotational model.
Clause 19. The method as recited in clause 16, wherein the trigger event is a timed event or a detected event.
Clause 20. The method as recited in clause 12, wherein the one or more eye features extracted from an image captured by the camera that are input to the gaze estimator include one or more of glints, pupil features, iris features, and limbus features.
Clause 21. A device, comprising:
a gaze estimator comprising one or more processors configured to:
   estimate a glint-based gaze vector from glint information obtained from one or more images of an eye captured by a camera under constraint of a rotational model of the eye, wherein a glint is a reflection of a light source off the eye; and
   generate a gaze vector based on the glint-based gaze vector and other eye features obtained from the one or more images of the eye.
Clause 22. The device as recited in clause 21, wherein, to generate a gaze vector based on the glint-based gaze vector and eye features, the gaze estimator is configured to:
input the rotational model and the eye features to a trained neural network, wherein the neural network estimates a feature-based gaze vector from the other eye features under constraint of the rotational model; and
evaluate the glint-based gaze vector and the feature-based gaze vector to determine the gaze vector.
Clause 23. The device as recited in clause 22, wherein, to evaluate the glint-based gaze vector and the feature-based gaze vector to determine the gaze vector, the gaze estimator is configured to:
determine a confidence level for the glint-based gaze vector and a confidence level for the feature-based gaze vector; and
determine the gaze vector based on the respective confidence levels.
Clause 24. The device as recited in clause 21, wherein, to generate a gaze vector based on the glint-based gaze vector and other eye features, the gaze estimator is configured to:
input the rotational model, the glint-based gaze vector, and the other eye features to a trained neural network, wherein the neural network estimates the gaze vector from the other eye features and the glint-based gaze vector under constraint of the rotational model.
Clause 25. The device as recited in clause 24, wherein the glint-based gaze vector is used as a constraint in the neural network when estimating the gaze vector.
Clause 26. The device as recited in clause 21, wherein a center of the eye used in estimating the glint-based gaze vector and in generating a gaze vector based on the glint-based gaze vector and other eye features is not constrained to a single point.
Clause 27. The device as recited in clause 21, further comprising a reference estimator comprising one or more processors configured to process one or more images captured by the camera to generate the rotational model of the eye in response to a trigger event.
Clause 28. The device as recited in clause 21, wherein the rotational model indicates position of the eye with respect to the device in at least three degrees of freedom.
Clause 29. The device as recited in clause 21, wherein the other eye features include one or more of pupil features, iris features, and limbus features.
Clause 30. The device as recited in clause 21, wherein the device is a head-mounted device (HMD) of an extended reality (XR) system.
Clause 31. A method, comprising:
performing, by a controller comprising one or more processors:
   estimating a glint-based gaze vector from glint information obtained from one or more images of an eye captured by a camera under constraint of a rotational model of the eye, wherein a glint is a reflection of a light source off the eye; and
   generating a gaze vector based on the glint-based gaze vector and other eye features obtained from the one or more images of the eye.
Clause 32. The method as recited in clause 31, wherein generating a gaze vector based on the glint-based gaze vector and eye features comprises:
inputting the rotational model and the eye features to a trained neural network, wherein the neural network estimates a feature-based gaze vector from the other eye features under constraint of the rotational model; and
evaluating the glint-based gaze vector and the feature-based gaze vector to determine the gaze vector.
Clause 33. The method as recited in clause 32, wherein evaluating the glint-based gaze vector and the feature-based gaze vector to determine the gaze vector comprises:
determining a confidence level for the glint-based gaze vector and a confidence level for the feature-based gaze vector; and
determining the gaze vector based on the respective confidence levels.
Clause 34. The method as recited in clause 31, wherein generating a gaze vector based on the glint-based gaze vector and other eye features comprises inputting the rotational model, the glint-based gaze vector, and the other eye features to a trained neural network, wherein the neural network estimates the gaze vector from the other eye features and the glint-based gaze vector under constraint of the rotational model.
Clause 35. The method as recited in clause 34, wherein the glint-based gaze vector is used as a constraint in the neural network when estimating the gaze vector.
Clause 36. The method as recited in clause 31, wherein a center of the eye used in estimating the glint-based gaze vector and in generating a gaze vector based on the glint-based gaze vector and other eye features is not constrained to a single point.
Clause 37. The method as recited in clause 31, further comprising processing one or more images captured by the camera to generate the rotational model of the eye in response to a trigger event.
Clause 38. The method as recited in clause 31, wherein the rotational model indicates position of the eye with respect to the device in at least three degrees of freedom.
Clause 39. The method as recited in clause 31, wherein the other eye features include one or more of pupil features, iris features, and limbus features.
Clause 40. The method as recited in clause 31, wherein the device is a head-mounted device (HMD) of an extended reality (XR) system.
Clause 41. A system, comprising:
a display positioned in front of an eye;
a single camera configured to capture images of the eye, wherein the camera is positioned with respect to the display and the eye such that portions of the eye are occluded during eye rotation; and
a controller comprising one or more processors configured to estimate a gaze vector from one or more eye features obtained from an image of the eye captured by the camera under constraint of a rotational model of the eye, wherein the one or more eye features used to estimate the gaze vector depend on rotational position of the eye with respect to the camera.
Clause 42. The system as recited in clause 41, wherein the one or more eye features include one or more of glints, pupil features, iris features, and limbus features.
Clause 43. The system as recited in clause 41, further comprising at least one light source, wherein the controller is further configured to:
estimate a glint-based gaze vector from glint information obtained from the image of the eye captured by the camera under constraint of the rotational model of the eye, wherein a glint is a reflection of a light source off the eye; and
estimate the gaze vector based on the glint-based gaze vector and other eye features obtained from the image of the eye, wherein the other eye features include one or more of pupil features, iris features, and limbus features.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising:
a camera configured to capture images of an eye; and
a reference estimator comprising one or more processors configured to estimate a rotational model of the eye with at least three degrees of freedom, wherein a center of the eye is not constrained within the rotational model; and
a gaze estimator comprising one or more processors configured to estimate a two degree of freedom gaze vector from one or more eye features extracted from images of the eye captured by the camera under constraint of the rotational model that was estimated by the reference estimator.

2. The device as recited in claim 1, wherein, to estimate a gaze vector from the one or more eye features under constraint of the current rotational model, the gaze estimator inputs a current rotational model and the eye features to a neural network, wherein the neural network estimates the gaze vector from the input eye features under constraint of the current rotational model.

3. The device as recited in claim 1, wherein position of the eye with respect to the device is represented in the rotational model in three degrees of freedom as (X, Y, Z) coordinates in an image space, and wherein rotation of the eye and the gaze vector are represented in two degrees of freedom as azimuth and elevation.

4. The device as recited in claim 1, wherein, in estimating the gaze vector from the input eye features under constraint of the rotational model, a center of the eye used in estimating the gaze vector is not constrained to a single point.

5. The device as recited in claim 1, wherein the reference estimator is configured to process one or more images captured by the camera to generate the rotational model of the eye in response to a trigger event.

6. The device as recited in claim 5, wherein, to process the one or more images captured by the camera to generate a rotational model of the eye, the reference estimator is configured to:
extract at least one feature of the eye from the one or more images; and
generate the rotational model based at least in part on the extracted one or more features.

7. The device as recited in claim 6, wherein the at least one feature includes one or more of glints, pupil features, iris features, and limbus features.

8. The device as recited in claim 5, wherein, to process one or more images captured by the camera to generate the rotational model, the reference estimator is configured to input at least one feature of the eye extracted from one or more images captured by the camera to a neural network that outputs an estimate of the rotational model.

9. The device as recited in claim 5, wherein the trigger event is a timed event or a detected event.

10. The device as recited in claim 1, wherein the one or more eye features extracted from an image captured by the camera that are input to the gaze estimator include one or more of glints, pupil features, iris features, and limbus features.

11. The device as recited in claim 1, wherein the device is a head-mounted device (HMD) of an extended reality (XR) system.

12. A method, comprising:
performing, by a controller comprising one or more processors:
estimating a rotational model of the eye with at least three degrees of freedom, wherein a center of the eye is not constrained within the rotational model; and
estimating a two degree of freedom gaze vector from one or more eye features extracted from images of the eye captured by the camera under constraint of the rotational model of the eye that was estimated by the reference estimator.

13. The method as recited in claim 12, wherein estimating a gaze vector from the one or more eye features under constraint of the current rotational model comprises inputting the current rotational model and the eye features to a neural network, wherein the neural network estimates the gaze vector from the input eye features under constraint of the current rotational model.

14. The method as recited in claim 12, wherein the position of the eye with respect to the device is represented in the rotational model in three degrees of freedom as (X, Y, Z) coordinates in an image space, and wherein rotation of the eye and the gaze vector are represented in two degrees of freedom as azimuth and elevation.

15. The method as recited in claim 12, wherein, in estimating the gaze vector from the input eye features under constraint of the rotational model, a center of the eye used in estimating the gaze vector is not constrained to a single point.

16. The method as recited in claim 12, further comprising processing one or more images captured by the camera to generate the rotational model of the eye in response to a trigger event.

17. The method as recited in claim 16, wherein processing the one or more images captured by the camera to generate a rotational model of the eye comprises:
extracting at least one feature of the eye from the one or more images; and
generating the rotational model based at least in part on the extracted one or more features;
wherein the at least one feature includes one or more of glints, pupil features, iris features, and limbus features.

18. The method as recited in claim 16, wherein processing one or more images captured by the camera to generate the rotational model comprises inputting at least one feature of the eye extracted from one or more images captured by the camera into a neural network that outputs an estimate of the rotational model.

19. The method as recited in claim 16, wherein the trigger event is a timed event or a detected event.

20. The method as recited in claim 12, wherein the one or more eye features extracted from an image captured by the camera that are input to the gaze estimator include one or more of glints, pupil features, iris features, and limbus features.
